(19) United States
(12) Patent Application Publication
(10) Pub. No.: US 2023/0164137 A2
(43) Pub. Date: May 25, 2023

(54) ROUTER WITH LOGIN FUNCTIONALITY AND ACCESS CONTROL METHOD SUITABLE THEREFOR

(71) Applicant: Phoenix Contact GmbH & Co. KG, Blomberg (DE)

(72) Inventors: Gerrit BOYSEN, Detmold (DE); Ingo HILGENKAMP, Rietberg (DE); Andreas FUSS, Berlin (DE)

(21) Appl. No.: 17/311,250

(22) PCT Filed: Dec. 5, 2019
(86) PCT No.: PCT/EP2019/083783

§ 371 Date: Jun. 4, 2021

(30) Foreign Application Priority Data
Dec. 6, 2018 (BE) BE2018/5857

(51) Int. Cl. H04L 29/06; H04L 12/24

(52) U.S. Cl. CPC H04L 63/083; H04L 63/102; H04L 63/20; H04L 41/22

(57) ABSTRACT

An access control method and a router, the router connected between at least two communication, installation or computer networks and equipped with login functionality and configured, for logging in a user, to grant the user access to predefined network zones and/or to network devices connected to the network zones following entry of login data recognized as permissible. The access method and router are characterized by an activation/deactivation device interacting with the login functionality provided on the router for temporarily activating and/or deactivating a login data input device required by the user for entering login data.

### FIELD

The present invention relates to a router, which is connected between at least two communication, installation or computer networks and is equipped with login functionality and configured, for logging in a user, to give said user access to predefined network zones and/or to network devices connected to said network zones following entry of login data recognized as permissible. The invention also relates to an access control method that is particularly suitable for such a router.

### BACKGROUND

As is known, communication, installation or computer networks, also generally referred to as networks in the context of the invention, can in and of themselves represent private networks or public networks and each form, for example, what are known as LANs (Local Area Networks) or WANs (Wide Area Networks), depending on the definition, as well as have a fundamentally different technical structure. Networks can consequently also cover a complete automation installation, production installation or office environment or even parts thereof, right up to individual network cells. Other examples include, for example, data centers or a public telephone network. Network devices connected within a network can, however, communicate with one another via a common medium and protocol and/or exchange data and can usually also share a number of resources. In the case of automation or production installations, for example, the network participants connected within a network communicate with one another, for example via a common Ethernet network.

To allow communication and/or the exchange of data across the boundaries of a network and/or, for example, to connect a network to the Internet or another network, routers are known to be often used at the outer boundaries of a network, which routers allow a plurality of networks to be connected to one another, even using different protocols or media. In the context of the invention, the term network thus also relates to sub-areas of such a network, right down to individual network cells, at the outer borders of which a router is then used.

Access from outside such a communication, installation or computer network to this network or to at least predefined network zones and/or to network devices connected to said network zones is therefore usually via a router and is usually only permitted for appropriately authorized users. Such users may be people, but also network devices from other networks. Such external access is also often necessary for remote maintenance and/or security applications for which a specific user has to access at least predefined network zones or network devices connected to said network zones from the outside. To prevent unauthorized users from externally accessing such zones or network devices connected to said zones, it is therefore generally necessary to first enter corresponding login data on or transfer it to the router to then give the user appropriate access according to the access authorization stored with respect to the login data to the network behind the router or to the network zones and network devices connected to said network zones and therefore protected by the router. For granted access, the establishment of a corresponding VPN tunnel to a specific network zone and/or to a network device can then, for example, also be initiated by the router.

An access control management system for access code-protected administrator-managed data sources having a remote querying means protected by a known access code is known from DE 10 2006 057 400 B4, the access control management system having a means to temporarily block remote querying using an access code known to be permissible. For this purpose, the access code known to a user, which is also known as permissible by the access control management system, is changed to a substitute code to be used instead that is, however, not known to the user whose access is to be blocked. Because the substitute code also replaces the permissible access code of an authorized user at the data source to be blocked, the generally authorized user would consequently also have to enter the unknown substitute code instead of the permissible access code to be granted access if his or her permissible access code is temporarily blocked.

A disadvantage here is that the access control management system must still, i.e., even in case of a temporarily blocked access code, actively check the access code entered by a user, i.e., compare the entered access code with the substitute code used for temporary blocking.

### SUMMARY

One object of the invention is therefore to provide a high level of security against unwanted external access to a network, even for users who are authorized in and of themselves, and, in particular, to at least temporarily prevent external access that is possible in principle, specifically in a simpler and, in particular, capacity-saving manner, in particular with regard to the components and resources that perform the check and/or grant requested access.

The object of the invention is already achieved by a router having the features according to claim 1 and by an access control method having the features according to claim 8.

The present invention thus proposes a router in which a login functionality is provided for logging in a user to grant said user access to predefined network zones and/or to network devices connected to said network zones following entry of login data recognized as permissible in such a way that an activation/deactivation device interacting with the login functionality is provided on the router for temporarily activating and/or deactivating a login data entry device required by the user for entering login data.

The invention also proposes an access control method, in particular for such a router, in which the entry of login data may be temporarily enabled and/or blocked by means of an activation/deactivation device to control access.

In contrast to the prior art cited above, in particular DE 10 2006 057 400 B4, when the solution according to the invention is used, an entered code or login data no longer needs to be checked if access to the network is to be temporarily blocked because in this case the entry of login data is already prevented. Access to the network is thus temporarily blocked in a much more resource-efficient manner because the permissibility of the login data entered no longer needs to be actively checked.

According to a further development, provision is made for the router to configure a login menu that can be called up via a desktop or browser as a login data entry device as part of the login functionality.

In a particularly preferred further development, the invention therefore also provides that the activation/deactivation device for temporarily deactivating the login data entry device merely prevents a visual display of the login menu.

Accordingly, a particularly preferred access control method is characterized in that the login data is entered via a desktop or a browser, and said login menu is blocked by preventing a visual display of this login menu.

In a supplementary or alternative further development, however, it is also expediently provided that the login functionality is configured for automated input of login data and/or for reading in login data using scanning or sensor devices when the login data entry device is temporarily activated.

In a further supplementary or alternative embodiment, it is provided that the activation/deactivation device has a switch, in particular a switch designed as hardware or software.

In an expedient further development, such a switch can be designed, for example, as a key operated switch or also as an HMI (Human Machine Interface) button.

According to a further supplementary or alternative further development, provision is also made for the activation/deactivation device to be configured in cooperation with the login functionality to activate and deactivate the login data entry device, regardless of any activated or deactivated communication connections.

### BRIEF DESCRIPTION OF THE DRAWINGS

Further advantages and features of the invention are apparent from the following description of some preferred embodiments with reference to the accompanying drawings, in which:

FIG. 1 is a partial view of a router with a first embodiment of an activation/deactivation device according to the invention in a highly schematic representation,

FIG. 2 is a partial view of a router with a second embodiment of an activation/deactivation device according to the invention in a highly schematic representation,

FIG. 3 is a partial view of a router with a third embodiment of an activation/deactivation device according to the invention in a highly schematic representation,

FIG. 4 is a partial view of a router with a fourth embodiment of an activation/deactivation device according to the invention in a highly schematic representation, and

FIG. 5 is a greatly simplified representation of a preferred embodiment of an access control method according to the invention.

### DETAILED DESCRIPTION

The following description of preferred embodiments of the invention is based on a router, which is connected between at least two communication, installation or computer networks and is equipped with login functionality and configured, for logging in a user, to give said user access to predefined network zones and/or to network devices connected to said network zones following entry of login data recognized as permissible. After access is granted to predefined network zones and/or to network devices connected to said network zones, the user is then generally forwarded accordingly via a user firewall and based on an individual set of rules.

By way of example, it is assumed that the previously necessary access to the login area provided in particular by the login functionality or to the login data entry device required for the entry of login data by the user of such a router is possible, for example, twenty-four hours a day and seven days a week. Service employees and administrators can therefore log in at any time using permissible login data, in particular using their user names and individual passwords, to externally access the network behind the router, i.e., in particular from a first network to the second network via the router used at the outer boundary of a second network. Such a router can, in particular, also separate individual network zones from one another, right down to the smallest network cells.

However, this can, for example, pose an unnecessary risk when a system is in operation. Consequently, it can be desirable that, for example, in the case of an installation in operation or a specific machine thereof, external access to the corresponding network, i.e., in particular to the network relating to the installation or specific machine, should or must not be possible.

Consequently, there are situations in which external access to a network should or must not be possible, even if a relevant user is appropriately qualified and/or is generally authorized as the only user and knows the correspondingly permissible login data, such as, in particular, the password and username.

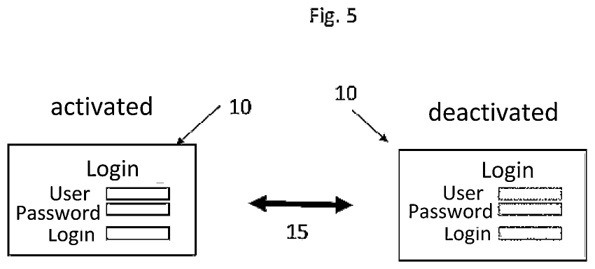

FIG. 5 illustrates a preferred embodiment of an access control method according to the invention for such situations in a greatly simplified representation. For example, according to the representation on the left in FIG. 5, login data must be entered and recognized as permissible login data to use the access possibility for an access functionality protected by login data to predefined network zones and/or to network devices connected to said network zones. This data is entered here as shown on the left in FIG. 5, for example, by means of the login menu 10, which can be called up via a desktop or browser, it being necessary in the example shown to enter a user name and a password in a corresponding entry field and then press the button labeled “Login,” whereupon a check for permissible login data is initiated for access control. In an activated state, as can be seen in the representation on the left in FIG. 5, the login data can be entered, and the entry of login data is consequently enabled.

In contrast to this, the illustration on the right in FIG. 5 shows a deactivated state. In such a state, no login data can be entered, and, consequently, the entry of login data is blocked. If a login menu 10 that can be called up via a desktop or browser is provided for entering the login data, for example according to FIG. 5, the blocking can preferably take place simply by suppressing a visual display of the login menu 10, as illustrated by the representation on the right in FIG. 5.

The enabling and/or blocking of the entry of or the possibility of entering login data is expediently done via an activation/deactivation device, as explained in more detail below, and can consequently be selected temporarily, i.e., the entry of login data can be temporarily enabled and/or temporarily blocked as needed, in particular by simply switching between the two states, as indicated by the double arrow designated by the reference sign 15. Access to predefined network zones and/or network devices connected to said network zones can therefore be checked at any time.

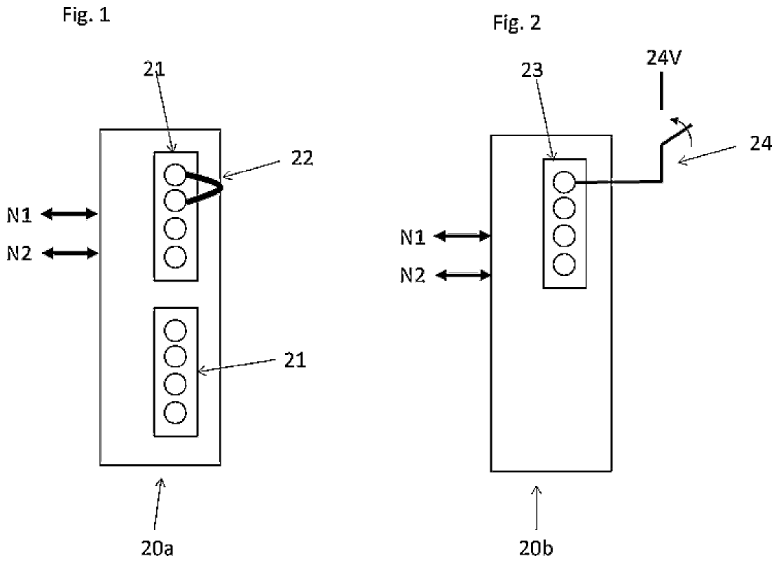

FIGS. 1 and 2 show, in a highly schematic representation, partial views of routers with a respective preferred embodiment of an activation/deactivation device according to the invention that is, in particular, implemented in hardware. Terminal blocks 21 and 23 present on a respective router 20a (FIG. 1) and 20b (FIG. 2) are illustrated. The terminal blocks 21 and 23 each include a number, in particular a plurality, of input terminals, and generally also a number, in particular a plurality, of output terminals. Such input and output terminals generally provide digital signal connections and are known per se to a person skilled in the art. The router 20a or 20b is connected between two networks, as indicated in FIGS. 1 and 2 by the double arrows designated N1 and N2. For example, the router 20a or 20b separates a specific network cell N1 from another network zone N2. The network cell N1 can, for example, correspond to a specific production cell of an installation network, at the outer boundary of which the router 20a, 20b is used in order to be able to control access from outside the network cell N1, i.e. in particular coming from the network or network zone N2.

The first embodiment illustrated in FIG. 1 provides for an activation/deactivation device according to the invention that interacts with the login functionality on the router in such a way that, by means of a contact bridge 22, two predefined terminals must be electrically connected to one another and directly in order to activate a login data entry device required by the user to enter login data (not shown in the figure for the sake of clarity).

As can be seen from the preceding description of FIG. 5, such a login data entry device can contain, for example, a login menu that is configured by the router as part of the login functionality and can be called up via a desktop or browser. If the contact bridge is removed and there is no direct electrical connection between the two predefined connections, the login data entry device is deactivated. The login data entry device can consequently be switched from an activated state to a deactivated state and vice versa at any time as needed.

As a modification of the embodiment according to FIG. 1, the second embodiment illustrated in FIG. 2 provides for a hardware solution in which a switch or button 24 is provided on the router, by means of which the login data entry device, which interacts with the login functionality but is not shown in the figure for the sake of clarity, can be temporarily activated and/or deactivated. The switch or button 24 can preferably be designed as a key operated switch, i.e. as an electrical switch that is combined with a lock for security reasons, such that the switching process can only be carried out by an authorized group of people with the aid of the appropriate key. Using the switch or button 24, for example, a predefined connection, in particular to a digital input, for entering the login data can initially be connected to a voltage potential, e.g. 24 V, necessary for this purpose. To block the possibility of entering login data, i.e. if external access to the network delimited by the router, e.g. coming from network N2 to network N1, should or should not be possible, the connection to the necessary voltage potential can temporarily be interrupted by means of the switch or button 24.

If, for example, a service employee wants to access the network N1 from N2, e.g. the network of a production cell, in order to configure a PLC (programmable logic controller) differently, he must first know basic permissible login data, e.g. his username and a correspondingly assigned password in order to pass the router 20a or 20b arranged between the networks N1 and N2, in particular for protection against the N2. The router 20a or 20b is therefore preferably a security router having a user firewall. Using the router according to the invention, security can now be increased to such an extent that logging in and the associated authentication of a user that is in principle authorized is only possible if the activation/deactivation device provided on the router is activated accordingly, e.g. a predefined digital input on the router is set accordingly, e.g. via a local key operated switch. If the activation/deactivation device is accordingly in a deactivated state, an attempt to log into the router is not possible. For example, the activation/deactivation device can be designed to prevent the visual display of a login menu as shown above. It can furthermore be provided in particular that an employee on site must first activate the activation/deactivation device accordingly, i.e., for example, turn the key operated switch into the position that activates and thus enables the entry of login data. The service employee must therefore first discuss this with the employee on site and receive the “mechanical approval” from him.

This has the particular advantage that an external user can only act in consultation with the operator of the network that the user wants to access externally (four-eyes principle). The operator of the network thus continues to retain sovereignty over his network, which is externally protected by the router according to the invention.

In a modification of the embodiments according to FIGS. 1 and 2, the activation/deactivation device can, in further preferred embodiments within the scope of the invention, also be designed entirely or in part in software, for example as a software-based HMI button or have such a software-based HMI button.

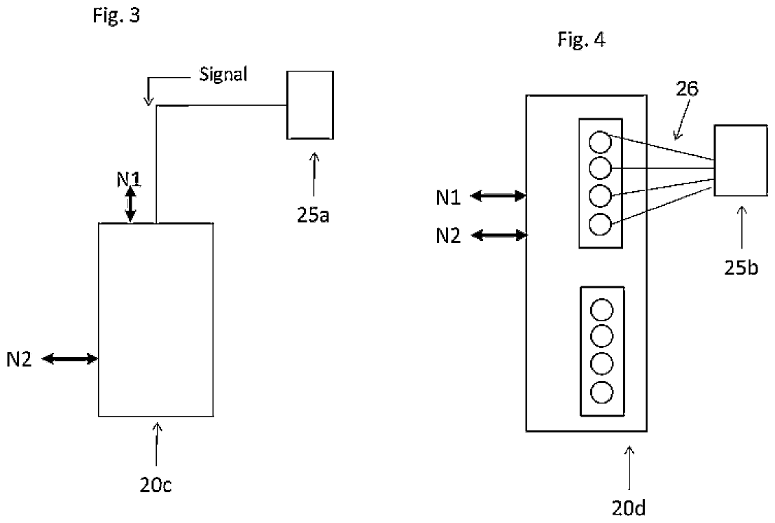

In the embodiment outlined in FIG. 3, for example, a further expedient modification provides that an activation/deactivation device of the router 20c provided within the scope of the invention comprises a control component 25a connected to said router, which control component is, in particular, connected via a network connection of the network N1, as well as a software switch, such that the software switch can be triggered according to a desired activated state or deactivated state via a control signal by means of the connected control component, i.e., to enable or block the possibility of entering login data.

In a further alternative, for example, according to an embodiment as illustrated in FIG. 4, a control component 25b connected to predefined terminals of a router 20d via separate or individual signal lines 26 can also be provided, in particular to, by means of corresponding control signals, temporarily activate and/or deactivate the login data entry device required for the entry of login data by the user.

It should be pointed out that, within the scope of the invention, it is not only possible to use a device via which the login data is to be entered manually as the login data entry device. Alternatively, devices with which an automatic or automated entry of login data takes place and/or in which the entry of login data can be detected by appropriate sensors, for example by fingerprint sensors, can be used as a login data entry device within the scope of the invention.

Furthermore, regardless of the respective design of the activation/deactivation device and/or the login functionality, the activation/deactivation device in cooperation with the login functionality is, however, expediently configured in such a way that it is possible to activate and deactivate the login data entry device, regardless of any activated or deactivated communication connections, such as VPN connections.

Taking into account the above description, the solution according to the invention can consequently also be used in particular in applications in which a VPN tunnel is not used, e.g. in communication from a production network zone to an individual production cell, and/or in applications where a VPN tunnel must be permanently established in a specific network or in a specific network zone, but access through the VPN tunnel is only to take place in consultation with the operator of this specific network or network zone.

1. A router, connected between at least two communication, installation or computer networks and is equipped with login functionality and configured, for logging in a user, to grant said user access to predefined network zones and/or to network devices connected to said network zones following entry of login data recognized as permissible, comprising an activation/deactivation device interacting with the login functionality is provided on the router for temporarily activating and/or deactivating a login data entry device required for the entry of login data by the user.

2. The router according to claim 1, wherein as part of the login functionality, a login menu that can be called up via a desktop or browser, is configured as a login data entry device.

3. The router according to claim 2, wherein the activation/deactivation device is designed to prevent a visual display of the login menu for temporary deactivation.

4. The router according to claim 1, wherein the login functionality is configured for automated input of login data and/or for reading in login data using scanning or sensor devices when a login data entry device is temporarily activated.

5. The router according to claim 1, wherein the activation/deactivation device is implemented in hardware and/or software.

6. The router according to claim 4, wherein the activation/deactivation device has a key operated switch or an HMI button.

7. The router according to claim 1, wherein the activation/deactivation device is configured to temporarily interrupt a voltage potential necessary for entering the login data.

8. The router according to claim 1, wherein the activation/deactivation device is configured in cooperation with the login functionality to activate and to deactivate the login data entry device, regardless of any activated or deactivated communication connections.

9. An access control method, for a router according to claim 1, for an access functionality protected by login data to predefined network zones and/or to network devices connected to said network zones, it being necessary for login data to be entered and recognized as permissible login data in order to use the access possibility, wherein to control access, the entry of login data may be temporarily enabled and/or blocked by means of an activation/deactivation device.

10. The access control method according to claim 9, wherein the login data is entered via a login menu that can be called up on a desktop or browser and is blocked by preventing a visual display of the login menu.

11. The access control method according to claim 9, wherein the access functionality is configured to support an automated login procedure for inputting login data to grant access to predefined network zones and/or to network devices connected to said network zones and/or to support the reading in of login data using scanning or sensor devices.
